(19) United States
(12) Patent Application Publication
(10) Pub. No.: US 2024/0111542 A1
(43) Pub. Date: Apr. 4, 2024

(54) PROCESSING GROUPS OF DATA IN PARALLEL

(71) Applicant: Black Sesame Technologies (Chengdu) Co., Ltd., Chengdu (CN)

(72) Inventor: Cheng Li, Wuhan (CN)

(21) Appl. No.: 18/477,324

(22) Filed: Sep. 28, 2023

(30) Foreign Application Priority Data
Sep. 29, 2022 (CN) 202211200964.1

(51) Int. Cl. G06F 9/38; G06F 9/30

(52) U.S. Cl. CPC G06F 9/38873; G06F 9/30036

(57) ABSTRACT

The present application discloses a method and an apparatus for a processor, and a computer-readable storage medium. The method for a processor includes: reading a plurality of groups of data from a data set by using a first vector instruction, where each group of data includes a plurality of pieces of data; performing an extremum operation on the plurality of groups of data in parallel by using a second vector instruction to obtain a first group of intermediate results; and calculating an extreme value of the data set based on the first group of intermediate results. In the foregoing technical solution, a plurality of groups of data in a data set are operated in parallel to determine an extreme value of the data set, which helps to improve a speed of data processing.

### CROSS-REFERENCE TO RELATED APPLICATION

This application claims the benefit under 35 U.S.C § 119(a) of the filing date of Chinese Patent Application No. 202211200964.1, filed in the Chinese Patent Office on Sep. 29, 2022. The disclosure of the foregoing application is herein incorporated by reference in its entirety.

### TECHNICAL FIELD

Embodiments of the present application relate to the field of processor technologies, and more specifically, to a method and an apparatus for a processor, and a computer-readable storage medium.

### BACKGROUND

Currently, searching for an extreme value (for example, a maximum value or a minimum value) in a data set (for example, an array or an image data set) is mainly implemented by performing pairwise comparison on data elements in the data set. However, in this manner, only two data elements can be compared at a time, and a data processing speed is relatively low.

### SUMMARY

Embodiments of the present application provide a method and an apparatus for a processor, and a computer-readable storage medium. Various aspects of the embodiments of the present application are described below.

According to a first aspect, a data processing method is provided, including: reading a plurality of groups of data from a data set by using a first vector instruction, where each group of data includes a plurality of pieces of data; performing an extremum operation on the plurality of groups of data in parallel by using a second vector instruction to obtain a first group of intermediate results; and calculating an extreme value of the data set based on the first group of intermediate results.

In a possible implementation, the second vector instruction is used for executing a maximum operation, and the method further includes: performing a minimum operation on the plurality of groups of data in parallel by using a third vector instruction to obtain a second group of intermediate results; and calculating a minimum value of the data set based on the second group of intermediate results.

In a possible implementation, performing the minimum operation on the plurality of groups of data in parallel by using the third vector instruction includes: after execution of the second vector instruction is completed and before an execution result of the second vector instruction is obtained, performing the minimum operation on the plurality of groups of data in parallel by using the third vector instruction.

In a possible implementation, the first vector instruction and the second vector instruction are instructions in a first looping code, and the first vector instruction and the second vector instruction are alternately executed for a plurality of times in the first looping code.

In a possible implementation, a vector instruction for processing the data set is an instruction in a NEON instruction set or an SSE instruction set.

In a possible implementation, the data in the data set is pixel data of an image.

According to a second aspect, a data processing apparatus is provided, and configured to perform the method according to the first aspect or any possible implementation of the first aspect.

According to a third aspect, a data processing apparatus is provided, including: a memory, configured to store an instruction; and a processor, configured to execute instructions stored in the memory, so as to perform the method according to the first aspect or any possible implementation of the first aspect.

According to a fourth aspect, a device-readable storage medium is provided, where the device-readable storage medium stores instructions used to perform the method according to the first aspect or any possible implementation of the first aspect.

According to a fifth aspect, a program product is provided, including instructions used to perform the method according to the first aspect or any possible implementation of the first aspect.

According to the data processing method provided in the embodiments of the present application, a comparison operation on a plurality of groups of data in a data set may be performed in parallel based on a vector instruction, so as to obtain an extreme value of the data set. Compared with a manner of performing pairwise comparison on data elements in a conventional solution, this solution may significantly improve the data processing speed.

### BRIEF DESCRIPTION OF THE DRAWINGS

FIG. 1 is a schematic flowchart of a data processing method according to an embodiment of the present application.

FIG. 2 is a schematic flowchart of another data processing method according to an embodiment of the present application.

FIG. 3 is a schematic structural diagram of a data processing method according to an embodiment of the present application.

FIG. 4 is a schematic structural diagram of a data processing apparatus according to an embodiment of the present application.

FIG. 5 is a schematic structural diagram of another data processing apparatus according to an embodiment of the present application.

### DETAILED DESCRIPTION OF THE EMBODIMENTS

The following clearly describes the technical solutions in the embodiments of the present application with reference to the accompanying drawings in the embodiments of the present application. Apparently, the described embodiments are merely some but not all of the embodiments of the present application.

The methods in this embodiment of the present application are used to search for an extreme value in a data set, for example, search for a maximum or minimum value in the data set. The data set may be, for example, an array or image data.

Currently, searching for a maximum value in a data set is mainly implemented by traversing data elements in the data set. Specifically, an initial extreme value of the data set may be first assigned based on data elements in the data set, and then the data elements in the data set may be compared with the initial data set extreme value one by one. For each traversed data element, the data element is compared with an extreme value of the current data set to determine whether the extreme value of the current data set needs to be updated. If the extreme value of the data set needs to be updated, the data element is used as an updated extreme value of the data set. By analogy, after all data elements in the data set are traversed, an extreme value (or may be referred to as a global extreme value) of the data set may be obtained.

In the foregoing process, the global extreme value needs to be updated based on a result of comparison between the data elements and an extreme value of the data set. For each data element that is traversed, the global extreme value is updated until the comparison result is obtained, which takes a long time. To improve a data processing speed, a CPU branch prediction mechanism may be used to update the global extreme value. Before a comparison result between a data element and the global extreme value is obtained, a processor may first predict the comparison result, and update the global extreme value based on a prediction result. If the prediction is correct, the processor may continue to perform subsequent operations. If the prediction fails, the processor needs to clear a pipeline and reload a correct branch for operation.

It may be learned from the foregoing process that, although the CPU branch prediction mechanism may improve the processing speed to some extent, there is still a possibility of prediction failure for the CPU branch prediction mechanism. If the prediction fails, pipeline rearrangement is caused, which is not conducive to improving data processing speed.

In addition, in the foregoing manner, in a process of determining an extreme value of a data set, data elements in the data set need to be traversed in sequence, and only two data elements can be compared at a time, and parallel comparison cannot be performed, thereby affecting the data processing speed.

In view of the foregoing problem, according to the data processing methods provided in the embodiments of the present application, a comparison operation on a plurality of groups of data in a data set may be performed in parallel based on a vector instruction, so as to obtain an extreme value of the data set. Compared with a manner of performing pairwise comparison on data elements in a conventional solution, this solution may significantly improve the data processing speed.

The methods in the embodiments of the present application may be applied to technical fields such as machine learning, artificial intelligence, and image processing. The methods in the embodiments of the present application may be executed by a processor. The processor may include a plurality of vector registers. Each vector register in the plurality of vector registers includes a plurality of channels, and each channel in the plurality of channels may be separately configured to store one data element. It should be noted that a quantity of channels included in a vector register is related to a size of a data element. For example, if a bit width of a vector register is 128 bits and a size of a data element is 16 bits, the vector register may include eight channels, that is, the vector register may store eight data elements. Similarly, if a size of a data element is 32 bits, the vector register may store four data elements.

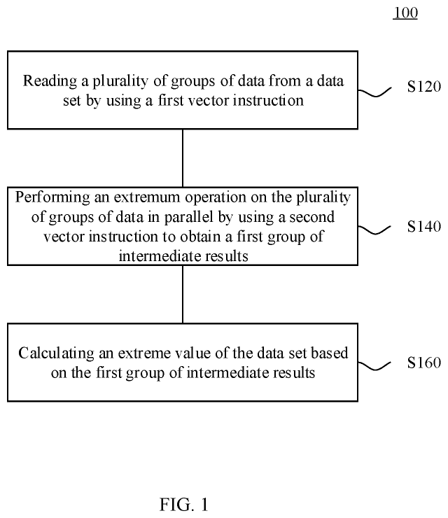

FIG. 1 is a schematic flowchart of a data processing method according to an embodiment of the present application. As shown in FIG. 1, the data processing method 100 may include steps S120 to S160.

Step S120: Reading a plurality of groups of data from a data set by using a first vector instruction.

The first vector instruction may be a vector read instruction. The first vector instruction may read a group of data from the data set each time, and then load the group of data into a vector register of a processor. It should be understood that, the data set may include a plurality of groups of data, and the first vector instruction may be used repeatedly to read the plurality of groups of data in the data set for a plurality of times until the plurality of groups of data are all loaded into the vector register of the processor.

It should be noted that, the first vector instruction may be used to load the plurality of groups of data into one vector register of the processor, or a plurality of vector registers of the processor.

In some embodiments, the data set may be, for example, an array or image data. That the data set is image data is used as an example, and data elements in the data set may be pixel data of an image. Each group of data in the plurality of groups of data in the data set may include a plurality of data elements.

In some embodiments, if the data set is image data (for example, a size of an image is 4000 pixels in width and 3000 pixels in height), full-image data offset is generally used in a conventional technology to acquire the image data. For example, currently if eight data elements in column 1 to column 8 of row 2000 need to be acquired, an offset of row 1 to row 1999 needs to be calculated, which causes a relatively large calculation amount. In view of this problem, the embodiment of the present application proposes acquiring image data by performing row-column decomposition on an image, that is, acquiring data based on offset of rows or columns. For example, currently if eight data elements in column 1 to column 8 in row 2000 need to be acquired, an offset may be calculated from the first data element in row 2000, so that eight data elements in column 1 to column 8 in row 2000 may be quickly acquired. In addition, an amount of data that needs to be cached in a memory is greatly reduced, thereby improving memory locality during acquiring of image data. Certainly, there may be performance differences between different platforms, and an adjustment may be made based on an experiment.

Step S140: Performing an extremum operation on the plurality of groups of data in parallel by using a second vector instruction to obtain a first group of intermediate results.

The second vector instruction may be an extremum operation instruction, such as a maximum value operation instruction vmax or a minimum value operation instruction vmin. In other words, if a current extremum operation is the maximum value operation, the second vector instruction is vmax. If a current extremum operation is the minimum value operation, the second vector instruction is vmin.

In some embodiments, the processor may include, for example, a target vector register and a first vector register, and both the target vector register and the first vector register may refer to any vector register in the processor. A plurality of channels of the target vector register are in a one-to-one correspondence with a plurality of channels of the first vector register. The following describes “performing an extremum operation on the plurality of groups of data in parallel” by way of example.

The data set may include, for example, N groups of data, and N is a positive integer greater than 1. As an example, the target vector register may be first assigned a value. For example, any group of data elements in the plurality of groups of data may be loaded into the target vector register as an initial value. Then a group of data in remaining N-1 groups of data may be loaded into the first vector register. Then, a comparison operation may be performed in parallel by using the second vector instruction on data elements in a corresponding channel of the target vector register and the first vector register, and an extreme value of the corresponding channel is updated to the target vector register based on a result of the operation, so that the extreme value of the corresponding channel is substantially always stored in the target vector register. Remaining data groups are continuously loaded into the first vector register, and then an extremum operation is performed in parallel on the remaining data groups and data in the target vector register until the N-1 groups of data in the data set are traversed. The first group of intermediate results may be a group of extreme value data, obtained after the N-1 groups of data in the data set are traversed, of a plurality of channels stored in the target vector register.

It should be understood that, if the second vector instruction is vmax, the first group of intermediate results may be a group of maximum values corresponding to the plurality of channels of the target vector register; if the second vector instruction is vmin, the first group of intermediate results may be a group of minimum values corresponding to the plurality of channels of the target vector register.

In some embodiments, a maximum value operation and a minimum value operation may be performed alternately when an extremum operation is performed in parallel on the plurality of groups of data in the data set. In an example, if the second vector instruction is vmax, after the second vector instruction is executed, a third vector instruction (namely, the instruction vmin) may be used to perform a minimum value operation on the plurality of groups of data in parallel to obtain a second group of intermediate results, and then a next alternating loop is performed, that is, performing a maximum value operation again, and then performing a minimum value operation again. The second group of intermediate results may be a group of minimum values corresponding to the plurality of channels of the second target vector register. A process of obtaining the second group of intermediate results is similar to that of obtaining the first group of intermediate results. For details, reference may be made to a process of obtaining the first group of intermediate results. Details are not described herein.

In some embodiments, in a scenario in which a maximum value and a minimum value of the data set are operated alternately, the target vector register may include a first target vector register and a second target vector register. The first target vector register may be configured to perform a maximum value operation, and the second target vector register may be configured to perform a minimum value operation. In other words, a maximum value operation may be performed on a corresponding channel of the first vector register and the first target vector register in parallel by using the second vector instruction, and a minimum value operation may be performed on a corresponding channel of the first vector register and the second target vector register in parallel by using the third vector instruction.

In some embodiments, in a scenario in which a maximum value and a minimum value of the data set are operated alternately, to avoid excessive repetitive inputs of the instruction vmax and the instruction vmin, a looping code may be established (for example, may be a “for” loop in C language). In other words, both the instruction vmax and the instruction vmin are instructions in the looping code, and a plurality of groups of data in the data set may be quickly traversed by using the looping code.

It should be noted that, a determining process is required for each code loop, and the determining process increases time for data processing. Therefore, in this embodiment of the present application, instructions in the looping code may be expanded, for example, the first vector instruction and the second vector instruction may be executed alternately for a plurality of times in one loop of the looping code. Certainly, the first vector instruction, the second vector instruction, and the third vector instruction may be executed alternately for a plurality of times in one loop of the looping code. In this way, a quantity of loops may be reduced, and a data processing speed may be improved. An example in which the looping code includes the instruction vmax and the instruction vmin is used for description. In an example, an instruction for alternately executing vmax and vmin four times may be set in one loop of the looping code. Certainly, a quantity of times of alternating execution of the instruction vmax and the instruction vmin in one loop of the looping code may be adjusted depending on performance differences of different platforms, so as to find an optimal speed.

It should be noted that, an instruction period of a NEON instruction set includes an instruction execution period and a quantity of periods to be delayed and waited for after instruction execution completes. The instruction vmax is used as an example. Execution of the instruction vmax requires one instruction period, and after the execution is completed, it needs to wait for three instruction periods to acquire execution result data of the instruction vmax. Similarly, execution of the instruction vmin requires one instruction period, and after the execution is completed, it needs to wait for three instruction periods to acquire execution result data of the instruction vmin. Therefore, to improve a data processing speed, in this embodiment of the present application, after execution of the second vector instruction (vmax) is completed and before an execution result of the second vector instruction is obtained, a minimum value operation may be performed on the plurality of groups of data in parallel by using the third vector instruction (vmin). Certainly, it may be alternatively that after execution of the third vector instruction (vmin) is completed and before an execution result of the third vector instruction is obtained, a maximum value operation may be performed on the plurality of groups of data in parallel by using the second vector instruction (vmax). In this way, three instruction periods may be reduced in one loop period in which the instruction vmax and the instruction vmin are executed alternately.

Step S160: Calculating an extreme value of the data set based on the first group of intermediate results.

After the first group of intermediate results are obtained, pairwise comparison is performed on a plurality of data elements in the first group of intermediate results may be compared in sequence in a basic logic implementation manner, so that the extreme value of the data set may be obtained.

In some embodiments, if the second vector instruction is vmax, a maximum value Max of the data set may be calculated by using the first group of intermediate results; if the second vector instruction is vmin, a minimum value Min of the data set may be calculated by using the first group of intermediate results.

In some embodiments, if data in the data set cannot be evenly divided by a bit width of the vector register, that is, a quantity of data elements in the last group of the data set is less than a quantity of data elements in another group. In this case, the method in this embodiment of the present application may be first used to perform parallel data processing to obtain an extreme value of first N-1 groups of data, for example, a maximum value Max and a minimum value Min. Then the extreme value is compared with the last group of data elements. For example, each data element in the last group of data elements may be compared with the extreme value of first N-1 groups of data to obtain a global extreme value of the data set.

It should be noted that, the foregoing mentioned vector instruction may be an instruction in the NEON instruction set or an SSE instruction set. In other words, the vector instruction may be an instruction in a single instruction multiple data (single instruction multiple data, SIMD) instruction set.

It may be learned from the foregoing content that, according to the data processing method provided in the embodiments of the present application, a comparison operation on a plurality of groups of data in a data set may be performed in parallel based on a vector instruction, so as to obtain an extreme value of the data set. Compared with a manner of performing pairwise comparison on data elements in a conventional solution, this solution may significantly improve a data processing speed. In addition, in parallel computing, in this embodiment of the present application, a condition selection instruction may be used for comparison, so that a problem of a CPU branch prediction failure may be avoided, helping improve the data processing speed.

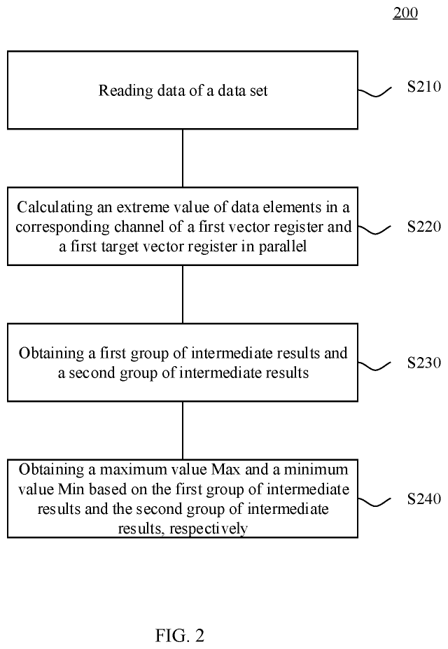

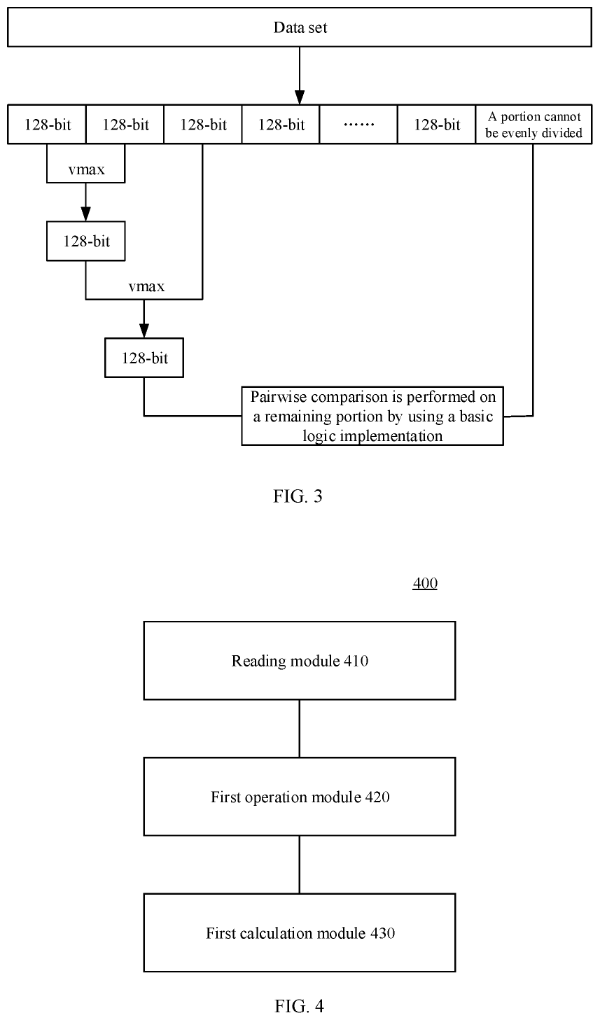

To deepen understanding of the foregoing data processing method 100, an example in which a processor includes a plurality of vector registers, the plurality of vector registers are all 128 bits, the vector instruction is an instruction in the NEON instruction set, the data set includes N groups of data, the data in the data set is pixel data of an image, and data of one pixel is 16 bits is used as an example for description below with reference to FIG. 2 and FIG. 3. FIG. 2 shows a possible implementation of “performing an extremum operation on the plurality of groups of data in parallel”. A data processing method 200 may include the following steps: S210 to 240.

Step S210: Reading data of a data set by using a vector instruction vld (vld may be a read instruction) of a NEON instruction set, for example, 128-bit data (namely, a first group of data) of image data may be read at a time, that is, data of eight pixels is actually read; and the loading the first group of data into a first target vector register and a second target vector register by using temporary variables nMax and nMin, where the first target vector register may be configured to perform a maximum value operation, and the second target vector register may be configured to perform a minimum value operation.

It should be understood that, before Step S210, the method further includes: setting any three vector registers in the processor to a first target register, a second target register, and a first vector register respectively by using an instruction in the NEON instruction set, and also setting two 128-bit temporary variables nMax and nMin, where The nMax may be used to update a value of the first target vector register, and the nMin may be used to update a value of the second target vector register.

Further, at the end of the first group of data, a second group of 128-bit data in the data set is continuously read and loaded into the first vector register.

Step S220: Calculating a maximum value of data elements in a corresponding channel of the first vector register and the first target vector register in parallel by using an instruction vmax (vmax may be a maximum value comparison instruction) of the NEON instruction set, and then updating a result obtained through comparison and calculation to the first target vector register by using the variable nMax. In other words, data of eight pixels may be compared in parallel simultaneously by using the instruction vmax in the NEON instruction set, and each data in the first target vector register is updated as a larger one.

Similarly, a minimum value of data elements in a corresponding channel of the first vector register and the second target vector register may be calculated in parallel by using an instruction vmin of the NEON instruction set, and then the second target vector register is updated based on a result obtained through comparison and calculation.

Step S230: Repeating comparison of the maximum value and the minimum value in Step S220 in loops, where a group of eight pieces of maximum value data and a group of eight pieces of minimum value data (that is, new nMin and nMax data are obtained) are obtained through comparison in each loop, and then updating the first target vector register and the second target vector register. After the loops end, a first group of intermediate results (namely, a group of maximum data of a plurality of channels in the first target vector register) and a second group of intermediate results (namely, a group of minimum data of a plurality of channels in the second target vector register) may be obtained.

To avoid excessive repetitive inputs of the instruction vmax and the instruction vmin, a looping code may be established (for example, may be a “for” loop in C language). In other words, both the instruction vmax and the instruction vmin are instructions in the looping code, and a plurality of groups of data in the data set may be quickly traversed by using the looping code.

It should be noted that, a determining process is required for each code loop, and the determining process increases time for data processing. Therefore, in this embodiment of the present application, instructions in the looping code may be expanded, for example, the instruction vmax and the instruction vmin may be executed alternately for a plurality of times in one loop of the looping code, so as to reduce a quantity of loops, and improve a data processing speed. Certainly, a quantity of times of alternating execution of the instruction vmax and the instruction vmin in one loop of the looping code may be adjusted depending on performance differences of different platforms, so as to find an optimal speed.

It should be noted that, an instruction period of a NEON instruction set includes an instruction execution period and a quantity of periods to be delayed and waited for after instruction execution completes. The instruction vmax is used as an example. Execution of the instruction vmax requires one instruction period, and after the execution is completed, it needs to wait for three instruction periods to acquire execution result data of the instruction vmax. Similarly, execution of the instruction vmin requires one instruction period, and after the execution is completed, it needs to wait for three instruction periods to acquire execution result data of the instruction vmin. Therefore, to improve a data processing speed, in this embodiment of the present application, after execution of the second vector instruction (vmax) is completed and before an execution result of the second vector instruction is obtained, a minimum value operation may be performed on the plurality of groups of data in parallel by using the third vector instruction (vmin). Certainly, it may be alternatively that after execution of the third vector instruction (vmin) is completed and before an execution result of the third vector instruction is obtained, a maximum value operation may be performed on the plurality of groups of data in parallel by using the second vector instruction (vmax). In this way, three instruction periods may be reduced in one loop period in which the instruction vmax and the instruction vmin are executed alternately.

It may be learned that, compared with the basic logic implementation manner in a conventional solution in which pairwise comparison is performed on data elements, a quantity of loops of parallel computation in this embodiment of the present application is approximately equal to ⅛ quantity of loops of that in a basic logic implementation.

Step S240: Performing pairwise comparison on a group (eight pieces of data) of maximum data of a plurality of channels in the first target vector register in sequence in a basic logic implementation manner, to obtain a maximum value Max after seven loops; and similarly, comparing a group of minimum data of a plurality of channels in the second target vector register one by one to obtain a minimum value Min.

In some embodiments, if data in the data set may be evenly divided by a bit width (namely, 128 bits) of the vector register, the maximum value Max is a maximum value of the data set and the minimum value Min is a minimum value of the data set.

In some embodiments, the data in the data set cannot be evenly divided by the bit width (namely, 128 bits) of the vector register, that is, a quantity of data elements in the last group of the data set is less than a quantity of channels included in the vector register, or a quantity of data elements in the last group of the data set is less than a quantity of data elements in another group. In this case, the method in this embodiment of the present application may be first used to perform parallel data processing to obtain a maximum value Max and a minimum value Min of first N-1 groups of data. To reduce computation complexity, during comparison of the last group of data elements, each data element in the last group of data elements may be compared one by one with the maximum value Max and the minimum value Min in a conventional manner, so as to update the maximum value Max and the minimum value Min. Because a quantity of the last group of data elements is not large, a manner of pairwise comparison does not greatly affect a processing speed.

For a case in which data in the data set cannot be evenly divided by a bit width of a vector register, obtaining a maximum value of the data set is used as an example. Referring to FIG. 3, a first group of data may be loaded into a first target vector register, a second group of data is loaded into a first vector register, and a maximum value of data elements in a corresponding channel of the first target vector register and the first vector register is calculated in parallel. Then, the first target vector register is updated based on a result of the comparison and calculation. Next, a third group of data is loaded into the first vector register, and a maximum value of data elements in the corresponding channel of the first target vector register and the first vector register is calculated in parallel. Then, the first target vector register is updated based on a result of the comparison and calculation. By analogy, N-1 groups of data are traversed. Finally, pairwise comparison may be performed on eight pieces of data in the first target vector register in sequence in a basic logic implementation manner, to obtain a maximum value Max. To reduce computation complexity, during comparison of the last group of data elements, each data element in the last group of data elements may be compared with the maximum value Max in the basic logic implementation manner, to obtain a global maximum value of the data set.

The following further describes effects of this embodiment of the present application with reference to experimental data in Table 1.

Experimental conditions: A hardware experimental platform in this embodiment of the present application is a Qualcomm Snapdragon 665 mobile processing platform, with a CPU processor Qualcomm Kryo 260 CPU (8 cores, maximum primary frequency up to 2 GHz), and based on an ARM architecture. A software experimental platform may be an Android 64-bit operating system.

The experiment includes two tests.

Test 1: Acquiring an extreme value (including acquiring a maximum value and a minimum value of a data set) of image data by means of basic logic implementation (that is, performing pairwise comparison of data elements one by one).

Test 2: Acquiring an extreme value (including acquiring a maximum value and a minimum value of a data set) of image data according to the data processing method based on parallel computing provided in this embodiment of the present application.

In the same hardware and software environments, an image with pixels of two data types (8 bits and 16 bits) is tested by using a same input parameter (a size of the image is 4000 pixels in width and 3000 pixels in height). Table 1 is a comparison between results of time used to process data corresponding to Test 1 and Test 2.

TABLE 1

| | | Data processing method in this |
|---|---|---|
| Data | Basic logic | embodiment of the present |
| type | implementation | application |
| 8 bits | 9.178 ms | 1.074 ms |
| 16 bits | 18.894 ms | 2.1796 ms |

On a premise that a program function is correct, the data processing time in Table 1 is an average time for calculating 10 times of program running. It may be learned from the foregoing table that, compared with the basic logic implementation, in the data processing method in this embodiment of the present application, in an ARM architecture, a running time for collecting statistics on a maximum value and a minimum value of an image pixel is greatly reduced, and processing speeds are improved by about 9 times for both 8-bit and 16-bit data type images.

It should be noted that, for 8-bit data, a quantity of loops is theoretically reduced by 16 times, but the speed is actually increased merely by about 9 times, and does not reach 16 times. A main reason is as follows: When an instruction vld in a NEON instruction set is used to acquire memory data, a delay exists (for example, a maximum delay may be 8 instruction periods), and a loss of read based on the instruction vld is relatively large. In addition, although the method in this embodiment of the present application reduces a loop determining process (for example, determining of “if” statement), and may further improve the data processing speed, a loss of read based on the instruction vld for 8-bit data is greater, and thus the data processing speed does not reach a theoretical level.

It should be noted that, for 16-bit data, a quantity of loops is theoretically reduced by eight times, but the speed is actually increased by more than eight times (see Table 1, which is about nine times). A main reason is as follows: For 16-bit data, a data processing improvement speed obtained due to reduction of loop determining process is higher than a loss speed due to vld read, which results in a seemingly unreasonable case that “a speed for 16-bit data type image may be increased by about 9 times”.

It should be noted that, the data in Table 1 are all measured data in the foregoing experimental conditions.

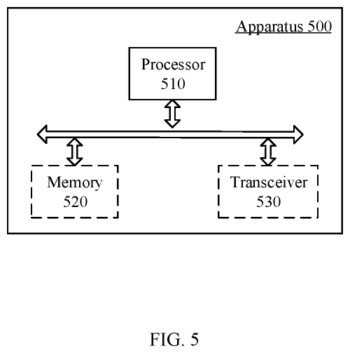

The methods embodiments of the present application are described in detail above with reference to FIG. 1 to FIG. 3. The apparatus embodiments of the present application are described in detail below with reference to FIG. 4 and FIG. 5. It should be understood that the description of the method embodiments corresponds to the description of the apparatus embodiments, and therefore, for parts that are not described in detail, reference may be made to the foregoing method embodiments.

An embodiment of the present application provides a data processing apparatus, and the data processing apparatus 400 may be configured to perform the methods described in any one of the foregoing method embodiments. Specifically, as shown in FIG. 4, the data processing apparatus 400 may include a reading module 410, a first calculation module 420, and a first calculation module 430.

The reading module 410 may be configured to read a plurality of groups of data from a data set by using a first vector instruction, where each group of data includes a plurality of pieces of data.

The first operation module 420 may be configured to perform an extremum operation on the plurality of groups of data in parallel by using a second vector instruction to obtain a first group of intermediate results.

The first calculation module 430 may be configured to calculate an extreme value of the data set based on the first group of intermediate results.

Optionally, the second vector instruction is used to execute a maximum value operation, and the apparatus 400 further includes: a second operation module 440, which may be configured to perform a minimum operation on the plurality of groups of data in parallel by using a third vector instruction to obtain a second group of intermediate results; and a second calculation module 450, which may be configured to calculate a minimum value of the data set based on the second group of intermediate results.

Optionally, performing the minimum operation on the plurality of groups of data in parallel by using the third vector instruction includes: after execution of the second vector instruction is completed and before an execution result of the second vector instruction is obtained, performing the minimum operation on the plurality of groups of data in parallel by using the third vector instruction.

Optionally, the first vector instruction and the second vector instruction are instructions in a first looping code, and the first vector instruction and the second vector instruction are alternately executed for a plurality of times in the first looping code.

Optionally, a vector instruction for processing the data set is an instruction in a NEON instruction set or an SSE instruction set.

Optionally, the data in the data set is pixel data of an image.

The following describes a data processing apparatus 500 in an embodiment of the present application with reference to FIG. 5. The dashed lines in FIG. 5 indicate that the units or modules are optional. The apparatus 500 may be configured to implement the methods described in the foregoing method embodiments. The apparatus 500 may be a computer or any type of electronic device.

The apparatus 500 may include one or more processors 510. The processor 510 may allow the apparatus 500 to implement the methods described in the foregoing method embodiments.

The apparatus 500 may further include one or more memories 520. The memory 520 stores a program, and the program may be executed by the processor 510 to cause the processor 510 to perform the methods described in the foregoing method embodiments. The memory 520 may be independent of the processor 510 or may be integrated into the processor 510.

The apparatus 500 may further include a transceiver 530. The processor 510 may communicate with another device by using the transceiver 530. For example, the processor 510 may transmit and receive data to and from another device by using the transceiver 530.

An embodiment of the present application further provides a machine-readable storage medium, configured to store a program, and the program causes a computer to perform the methods in the embodiments of the present application.

An embodiment of the present application further provides a computer program product. The computer program product includes a program. The program causes a computer to perform the methods in the embodiments of the present application.

An embodiment of the present application further provides a computer program. The computer program causes a computer to perform the methods in the embodiments of the present application.

All or some of the foregoing embodiments may be implemented by means of software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on the computer, the procedures or functions according to the embodiments of the present disclosure are completely or partially generated. The computer may be a general-purpose computer, a dedicated computer, a computer network, or another programmable apparatus. The computer instructions may be stored in a machine-readable storage medium or transmitted from one machine-readable storage medium to another machine-readable storage medium. For example, the computer instructions may be transmitted from a website, computer, server, or data center to another website, computer, server, or data center via a wired (such as a coaxial cable, an optical fiber, and a digital subscriber line (Digital Subscriber Line, DSL)) manner or a wireless (such as infrared, wireless, and microwave) manner. The machine-readable storage medium may be any usable medium readable by a computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

Persons of ordinary skill in the art may be aware that, units and algorithm steps in examples described in combination with the embodiments disclosed in the present disclosure can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

In several embodiments provided in this disclosure, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in the embodiments of the present disclosure may be integrated into one processing unit, or each of the units may exist alone physically, or two or more units may be integrated into one unit.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A data processing method, comprising:
reading a plurality of groups of data from a data set by using a first vector instruction, wherein each group of data comprises a plurality of pieces of data;
performing an extremum operation on the plurality of groups of data in parallel by using a second vector instruction to obtain a first group of intermediate results; and
calculating an extreme value of the data set based on the first group of intermediate results.

2. The method according to claim 1, wherein the second vector instruction is used for executing a maximum operation, and the method further comprises:
performing a minimum operation on the plurality of groups of data in parallel by using a third vector instruction to obtain a second group of intermediate results; and
calculating a minimum value of the data set based on the second group of intermediate results.

3. The method according to claim 2, wherein performing the minimum operation on the plurality of groups of data in parallel by using the third vector instruction comprises:
after execution of the second vector instruction is completed and before an execution result of the second vector instruction is obtained, performing the minimum operation on the plurality of groups of data in parallel by using the third vector instruction.

4. The method according to claim 2, wherein the first vector instruction and the second vector instruction are instructions in a first looping code, and the first vector instruction and the second vector instruction are alternately executed for a plurality of times in the first looping code.

5. The method according to claim 1, wherein a vector instruction for processing the data set is an instruction in a NEON instruction set or an SSE instruction set.

6. The method according to claim 1, wherein data in the data set is pixel data of an image.

7. The method according to claim 6, wherein the reading a plurality of groups of data from a data set by using a first vector instruction comprises:
reading the plurality of groups of data from the data set by using the first vector instruction based on a row offset or a column offset of the pixel data.

8. (canceled)

9. A data processing apparatus, comprising:
a memory, configured to store instructions; and
a processor, configured to execute instructions in the memory, so as to perform operations comprising:
reading a plurality of groups of data from a data set by using a first vector instruction, wherein each group of data comprises a plurality of pieces of data;
performing an extremum operation on the plurality of groups of data in parallel by using a second vector instruction to obtain a first group of intermediate results; and
calculating an extreme value of the data set based on the first group of intermediate results.

10. One or more non-transitory device-readable storage media, wherein the device-readable storage medium stores instructions for performing operations comprising:
reading a plurality of groups of data from a data set by using a first vector instruction, wherein each group of data comprises a plurality of pieces of data;
performing an extremum operation on the plurality of groups of data in parallel by using a second vector instruction to obtain a first group of intermediate results; and
calculating an extreme value of the data set based on the first group of intermediate results.

11. The data processing apparatus according to claim 9, wherein the second vector instruction is used for executing a maximum operation, and the method further comprises:
performing a minimum operation on the plurality of groups of data in parallel by using a third vector instruction to obtain a second group of intermediate results; and
calculating a minimum value of the data set based on the second group of intermediate results.

12. The data processing apparatus according to claim 11, wherein performing the minimum operation on the plurality of groups of data in parallel by using the third vector instruction comprises:
after execution of the second vector instruction is completed and before an execution result of the second vector instruction is obtained, performing the minimum operation on the plurality of groups of data in parallel by using the third vector instruction.

13. The data processing apparatus according to claim 11, wherein the first vector instruction and the second vector instruction are instructions in a first looping code, and the first vector instruction and the second vector instruction are alternately executed for a plurality of times in the first looping code.

14. The data processing apparatus according to claim 9, wherein a vector instruction for processing the data set is an instruction in a NEON instruction set or an SSE instruction set.

15. The data processing apparatus according to claim 9, wherein data in the data set is pixel data of an image.

16. The data processing apparatus according to claim 15, wherein the reading a plurality of groups of data from a data set by using a first vector instruction comprises:
reading the plurality of groups of data from the data set by using the first vector instruction based on a row offset or a column offset of the pixel data.

17. The one or more device-readable storage media according to claim 10, wherein the second vector instruction is used for executing a maximum operation, and the method further comprises:
performing a minimum operation on the plurality of groups of data in parallel by using a third vector instruction to obtain a second group of intermediate results; and
calculating a minimum value of the data set based on the second group of intermediate results.

18. The one or more device-readable storage media according to claim 11, wherein performing the minimum operation on the plurality of groups of data in parallel by using the third vector instruction comprises:
after execution of the second vector instruction is completed and before an execution result of the second vector instruction is obtained, performing the minimum operation on the plurality of groups of data in parallel by using the third vector instruction.

19. The one or more device-readable storage media according to claim 17, wherein the first vector instruction and the second vector instruction are instructions in a first looping code, and the first vector instruction and the second vector instruction are alternately executed for a plurality of times in the first looping code.

20. The one or more device-readable storage media according to claim 10, wherein a vector instruction for processing the data set is an instruction in a NEON instruction set or an SSE instruction set.
